(19) United States
(12) Patent Application Publication
(10) Pub. No.: US 2023/0384511 A1
(43) Pub. Date: Nov. 30, 2023

(54) HOLLOW CORE OPTICAL WAVEGUIDES AND METHODS FOR MODIFICATION THEREOF

(71) Applicant: University of Southampton, Southampton, Hampshire (GB)

(72) Inventors: Natalie WHEELER, Southampton, Hampshire (GB); Peter HORAK, Southampton, Hampshire (GB); Francesco POLETTI, Southampton, Hampshire (GB); Thomas KELLY, Southampton, Hampshire (GB); Matthew PARTRIDGE, Southampton, Hampshire (GB)

(21) Appl. No.: 18/245,273

(22) PCT Filed: Sep. 2, 2021
(86) PCT No.: PCT/GB2021/052266

§ 371 Date: Mar. 14, 2023

(30) Foreign Application Priority Data
Sep. 14, 2020 (GB) 2014418.4

(51) Int. Cl. G02B 6/02

(52) U.S. Cl. CPC G02B 6/02328; G02B 6/02347

(57) ABSTRACT

A hollow core optical waveguide comprises a hollow core; and a structured arrangement of longitudinally extending capillaries surrounding the hollow core to form a cladding; wherein one or both of the hollow core and the cladding contains gas configured to provide a refractive index difference between the hollow core and the cladding.

### BACKGROUND OF THE INVENTION

The present invention relates to hollow core optical waveguides and methods for modifying optical properties of hollow core optical waveguides.

Optical fibres (waveguides) comprising a core and a surrounding cladding both made from solid glass are well-known. More recently, optical fibres (waveguides) comprising one or more holes, lumen or capillaries extending along the length of the fibre have been developed. The presence of the holes allows the optical properties of the fibre to be altered and tailored compared to solid fibre. One class of so-called “holey fibres” is the hollow core optical fibre. This comprises a central hollow core region surrounded by a cladding made up of a number of holes arranged according to various structures. The structures can be chosen to guide light along the fibre via different mechanisms, and to control the optical properties and characteristics of the fibre. The hollow core provides a propagation path for light which is largely free from glass, so that linear and non-linear optical effects that arise when light interacts with glass can be reduced or avoided. This removes some propagation loss mechanisms, enables higher propagation speeds, supports broader optical bandwidths, and allows higher optical powers to be transmitted. Accordingly, hollow core fibres offer a range of benefits for many applications.

However, tailoring of optical properties via the choice of the fibre's internal structure offers a limited number of parameters for adjustment, and possible structures can be restricted by the fibre fabrication techniques which are available. Therefore, additional and alternative approaches for modifying the optical properties of hollow core fibre are of interest.

### SUMMARY OF THE INVENTION

Aspects and embodiments are set out in the appended claims.

According to a first aspect of certain embodiments described herein, there is provided a hollow core optical waveguide comprising: a hollow core; and a structured arrangement of longitudinally extending capillaries surrounding the hollow core to form a cladding; wherein one or both of the hollow core and the cladding contains gas configured to provide a refractive index difference between the hollow core and the cladding.

According to a second aspect of certain embodiments described herein, there is provided an optical device, optical apparatus or optical system comprising one or more hollow core optical waveguides according to the first aspect.

According to a third aspect of certain embodiments described herein, there is provided a method of modifying optical properties of a hollow core optical waveguide, comprising: providing a hollow core optical waveguide comprising a hollow core and a structured arrangement of longitudinally extending capillaries surrounding the hollow core to form a cladding; and changing a gas content of one or both of the hollow core and the cladding in order to achieve a refractive index difference between the hollow core and the cladding.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, optical waveguides and methods may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a schematic transverse cross-sectional view of an example hollow core photonic bandgap optical fibre to which the present disclosure is applicable;

FIG. 2 shows a schematic transverse cross-sectional view of a first example antiresonant hollow core optical fibre to which the present disclosure is applicable;

FIG. 3 shows a schematic transverse cross-sectional view of a second example antiresonant hollow core optical fibre to which the present disclosure is applicable;

FIG. 4 shows a scanning electron microscope image of an example antiresonant hollow core optical fibre used in experiments to demonstrate the concepts of the present disclosure;

FIG. 5 shows a schematic representation of example apparatus suitable for implementing and testing a method according to an example of the present disclosure.

FIG. 6A shows transmitted power spectra measured from the fibre of FIG. 4, before and during application of a method of optical property modification according to an example of the present disclosure;

FIG. 6B shows a graph of the variation of measured transmitted power over time from the fibre of FIG. 4 during application of a method according to an example of the present disclosure;

FIG. 7 shows a scanning electron microscope image of the example antiresonant hollow core optical fibre of FIG. 4, after sealing of an end by capillary collapse according to an example method of the present disclosure;

FIG. 8A shows transmitted power spectra measured from the fibre of FIG. 7, before and during application of a method of optical property modification according to an example of the present disclosure;

FIG. 8B shows a graph of the variation of measured transmitted power over time from the fibre of FIG. 7 during application of a method according to an example of the present disclosure;

FIG. 9 shows a graph of computer-modelled results of a simulation of optical propagation through a length hollow core optical fibre of the type shown in FIG. 4, showing loss as a function of wavelength for different values of pressure differential between the core and cladding of the fibre;

FIG. 10 shows a schematic side view of an end facet of a hollow core fibre sealed in accordance with an example of the present disclosure;

FIG. 11 shows a schematic side view of a hollow core fibre spliced at its ends to solid optical fibre in accordance with an example of the present disclosure; and

FIG. 12 shows a flow chart of steps in an example method according to the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of optical waveguides and methods discussed herein which are not described in detail may be implemented in accordance with any conventional techniques for implementing such aspects and features.

Solid core optical fibres, comprising a solid glass or polymer material core surrounded by a solid glass or polymer material cladding, guide light by the presence of a refractive index difference between the core and the cladding which causes total internal reflection at the core-cladding boundary. Hollow core optical fibres, in contrast, have a core in which light is guided comprising a central void, surrounded by a cladding comprising a structured arrangement of longitudinal capillaries extending along the fibre length. The absence of a solid glass core reduces the proportion of a guided optical wave which propagates in glass compared to a solid core fibre, offering benefits such as increased propagation speed, reduced loss from both absorption and scattering, and reduced nonlinear interactions. The structure means that a hollow core fibre comprises only a small proportion of glass or polymer within the total volume of the fibre. The majority of the interior of the fibre is taken up by the spaces and voids inside the hollow core and the capillaries that make up the cladding, the spaces and voids commonly being air-filled. The structure and size of these elements define the light guiding mechanism for any particular design of hollow core fibre. Examples of these are described further below. The presence of so little glass within a hollow core fibre makes most of its optical properties relatively (or in some cases completely) insensitive to the refractive index of the glass. Very large changes in refractive index of the glass structure (for example, greater than 0.1) are needed to produce even subtle changes in features such as the position of the spectral width of the guided wavelengths or bandgaps. For this reason, refractive index is not generally considered to be a parameter of significance for optimisation of the properties of hollow core optical fibres.

However, the present inventors have demonstrated the surprising effect that even a small difference in refractive index between the hollow core and the cladding capillaries can significantly change the optical properties of a hollow core fibre. It is proposed that this refractive index differential be achieved by adding gas to the interior of the fibre, configured as a gas content inside the hollow core which is different from the gas content inside the cladding. The presence of the gas alters the refractive index experienced by light propagating in the hollow core fibre, and by arranging that the gas fill in the core differs from that in the capillaries of the cladding, a refractive index differential is produced. The differential can be provided by the use of different gases or gas mixtures and/or different gas pressures of the same or different gases including the use of a vacuum in one of the core and the cladding and gas in the other. The modification of the properties can be made permanent by sealing the desired gas content inside the fibre. Alternatively, the modification can be alterable and/or reversible by allowing gas added to the fibre to be increased or removed at a later time, thereby providing a device with tunable optical properties. As examples, the modification may be used to improve optical characteristics beyond those which are achievable from the chosen structure of the hollow core fibre even under optimal manufacturing, or to enhance characteristics of a fibre which has been made sub-optimally by adjusting for defects arising from inferior manufacturing. The former case offers access to exceptional performance from fibres which are already able to provide excellent optical transmission. The latter case allows compensation for issues arising from what can be a challenging manufacturing process; it can be difficult to accurately align the various components that make up a hollow core fibre and then retain that alignment throughout the fibre fabrication.

Note that according to the proposed approach, the gas content of the hollow core fibre is altered after the fibre is fabricated. In other words, the modification of the optical properties is a post-fabrication method, applied to already-fabricated, existing, hollow core fibre so that a required gas content within the fibre configured to provide a particular refractive index effect is present when the fibre is used for light propagation. This is wholly different from unrelated known techniques in which gas is used to pressurise the core and/or cladding during fibre fabrication in order to achieve particular sizes of the various holes in the finished fibre, the gas and/or the pressurisation being removed before use of the fibre. Examples of this can be found in WO 2015/040187, WO 2015/040189 and WO 2019/025797 [1, 2, 3].

Herein, any reference to the refractive index of the core and the refractive index of the cladding refers to the refractive index values of the hollow core, and of the capillaries of the cladding, with or without a gas filling as specified.

Hollow core fibres can be categorised according to their mechanism of optical guidance into two principal classes or types: hollow core photonic bandgap fibre (HCPBF, alternatively often referred to as hollow core photonic crystal fibres, HCPCF) [4], and antiresonant hollow core fibre (AR-HCF or ARF) [5]. There are various subcategories of ARFs characterised by their geometric structure, including kagome fibres [6, 7], nested antiresonant nodeless fibres (NANFs) [8] and tubular fibres [9]. The present disclosure is applicable to all types of hollow core fibre, including these two main classes and their associated sub-types plus other hollow core designs. Note that in the art, there is some overlapping use of terminologies for the various classes of fibre. For the purposes of the present disclosure, the term “hollow core fibre” is intended to cover all types of these fibres having a hollow core as described above. The terms “HCPBF” and “HCPCF” are used to refer to hollow core fibres which have a structure that provides waveguiding by photonic bandgap effects (described in more detail below). The terms “ARF” and “antiresonant hollow core fibre” are used to refer to hollow core fibres which have a structure that provides waveguiding by antiresonant effects (also described in more detail below).

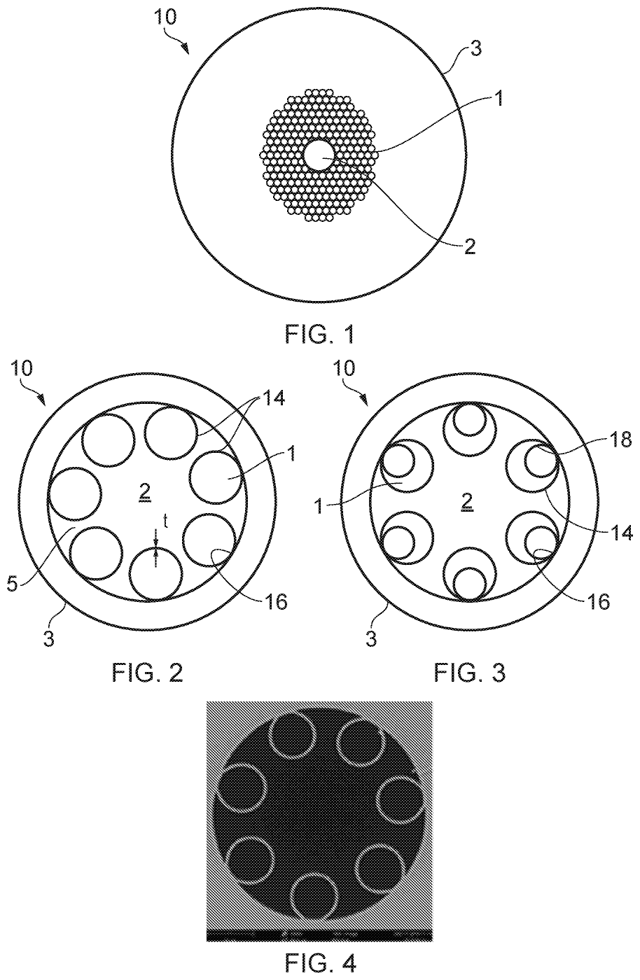

FIG. 1 shows a cross-sectional view of an example HCPBF 10. In this fibre type, the structured, inner, cladding 1 comprises a regular closely packed array of many small glass capillaries, from which a central group is excluded to define a substantially circular hollow core 2. The periodicity of the cladding structure provides a periodically structured refractive index and hence a photonic bandgap effect that confines the propagating optical wave towards the core. These fibres can be described in terms of the number of cladding capillaries or “cells” which are excluded to make the core 2. In the FIG. 1 example, the central nineteen cells from the array are absent in the core region, making this a 19-cell core HCPBF. The structured cladding 1 is formed from six rings of cells surrounding the core 2, plus some cells in a seventh ring to improve the circularity of the outer surface of the cladding. A solid outer cladding 3 surrounds the structured cladding 1.

In contrast to HCPBF, antiresonant hollow core fibres guide light by an antiresonant optical guidance effect. The structured cladding of ARFs has a simpler configuration, comprising a much lower number of larger glass capillaries or tubes than a HCPBF to give a structure lacking any high degree of periodicity so that photonic bandgap effects are not significant. Rather, antiresonance is provided for propagating wavelengths which are not resonant with a wall thickness of the cladding capillaries, in other words, for wavelengths in an antiresonance window which is defined by the cladding capillary wall thickness. The cladding capillaries surround a central void or cavity which provides the hollow core of the fibre, and which is able to support antiresonantly-guided optical modes. The structured cladding can also support cladding modes able to propagate primarily inside the capillaries, in the glass of the capillary walls or in the spaces or interstices between the cladding capillaries and the fibre's outer cladding. The loss for these additional non-core guided modes is generally very much higher than that for the core guided modes. The fundamental core guided mode typically has by far the lowest loss amongst the core guided modes. The antiresonance provided by a capillary wall thickness which is in antiresonance with the wavelength of the propagating light acts to inhibit coupling between the fundamental core mode and any cladding modes, so that light is confined to the core and can propagate at very low loss.

FIG. 2 shows a transverse cross-sectional view of an example simple antiresonant hollow core fibre. The fibre 10 has an outer tubular cladding 3. The structured, inner, cladding 1 comprises a plurality of tubular cladding capillaries 14, in this example seven capillaries of the same cross-sectional size and shape, which are arranged inside the outer cladding 3 in a ring, so that the longitudinal axes of each cladding capillary 14 and of the outer cladding 3 are substantially parallel. Each cladding capillary 14 is in contact with (bonded to) the inner surface of the outer cladding 3 at a location 16, such that the cladding capillaries 14 are evenly spaced around the inner circumference of the outer cladding 3, and are also spaced apart from each other by gaps 5 (there is no contact between neighbouring capillaries). In some designs of ARF, the cladding tubes 14 may be positioned in contact with each other (in other words, not spaced apart as in FIG. 2), but spacing to eliminate this contact can improve the fibre's optical performance. The spacing s removes optical nodes that arise at the contact points between adjacent tubes and which tend to cause undesirable resonances that result in high losses. Accordingly, fibres with spaced-apart cladding capillaries may be referred to as “nodeless antiresonant hollow core fibres”.

The arrangement of the cladding capillaries 14 in a ring around the inside of the tubular outer cladding 3 creates a central space, cavity or void within the fibre 10, also with its longitudinal axis parallel to those of the outer cladding 3 and the capillaries 14, which is the fibre's hollow core 2. The core 2 is bounded by the inwardly facing parts of the outer surfaces of the cladding capillaries 14. This is the core boundary, and the material (glass or polymer, for example) of the capillary walls that make up this boundary provides the required antiresonance optical guidance effect or mechanism. The capillaries 14 have a thickness t at the core boundary which defines the wavelength for which antiresonant optical guiding occurs in the ARF.

FIG. 2 shows merely one example of an ARF. Many other ARF structures are known and possible, and the use of gas filling for refractive index differentials as described herein is applicable to any of these.

FIG. 3 shows a transverse cross-sectional view of a second example ARF. The ARF has a structured inner cladding 1 comprising six cladding capillaries 14 evenly spaced apart around the inner surface of a tubular outer cladding 3 and surrounding a hollow core 2. Each cladding capillary 14 has a secondary, smaller capillary 18 nested inside it, bonded to the inner surface of the cladding capillary 14, in this example at the same azimuthal location 16 as the point of bonding between the primary capillary 14 and the outer cladding 3. These additional smaller capillaries 18 can reduce the optical loss. Additional still smaller tertiary capillaries may be nested inside the secondary capillaries 18. ARF designs of this type, with secondary and optionally smaller further capillaries, may be referred to as “nested antiresonant nodeless fibres”, or NANFs [5]. NAN Fs may also include smaller tubes or capillaries positioned to aid in defining the regularity of the cladding structure.

Many other capillary configurations for the structured cladding of an ARF are possible, and the disclosure is not limited to the examples described above. For example, the capillaries need not be of circular cross-section, and/or may or may not be all of the same size and/or shape. The number of capillaries surrounding the core may be for example, four, five, six, seven, eight, nine or ten, although other numbers are not excluded.

The ring of cladding capillaries in an ARF creates a core boundary which has a shape comprising a series of adjacent inwardly curving surfaces (that is, convex from the point of view of the core). This contrasts with the usual outward curvature of the core-cladding interface in a conventional solid core fibre, and the substantially circular core boundary of a HCPBF (see FIG. 1). Accordingly, antiresonant hollow core fibres can be described as negative curvature fibres. The kagome category of ARF can also be configured as negative curvature fibres, and has a structured cladding of multiple small capillaries in an array, similar to HCPBF, but not configured to provide photonic bandgaps. In contrast to HCPBF, the guidance mechanism operates by antiresonance effects.

Herein, the terms hollow core optical fibre, hollow core fibre, hollow core waveguide, hollow core optical waveguide and similar terms are intended to cover optical waveguiding structures configured according to any of the above examples and similar structures, where light is guided by any of several guidance mechanisms (photonic bandgap guiding, antiresonance guiding, inhibited coupling guiding) in a hollow elongate void or core surrounded by a structured cladding comprising a plurality of longitudinal capillaries. The capillaries comprise or define elongate holes, voids, lumina, cells or cavities which run continuously along the length or longitudinal extent of the optical fibre, substantially parallel to the elongate core which also extends continuously along the fibre's length. These various terms may be used interchangeably in the present disclosure.

While the concepts proposed herein are applicable to hollow core fibres in general, some specific experiments and modelling have been carried out using the particular example of a nodeless antiresonant fibre with seven cladding capillaries.

FIG. 4 shows a scanning electron microscope image of this ARF. The hollow core has a diameter of about 21 μm and the cladding capillaries have an internal diameter of about 9 μm; these values and this structure are an example only and are in no way limiting.

A variety of properties and characteristics of hollow core fibre can be altered, tuned or modified using the proposed gas fill-induced refractive index differential. Some will be discussed in more detail below, but a first example is the attenuation of the fibre, in other words the amount of loss in optical power caused to light propagating along the fibre. Experiments conducted using the fibre of FIG. 4 have shown that a refractive index difference between the core and the cladding can significantly reduce the attenuation, thereby improving performance available from the fibre (for example, lower power levels can be successfully transmitted, or longer lengths of fibre can be used, since total attenuation scales with fibre length).

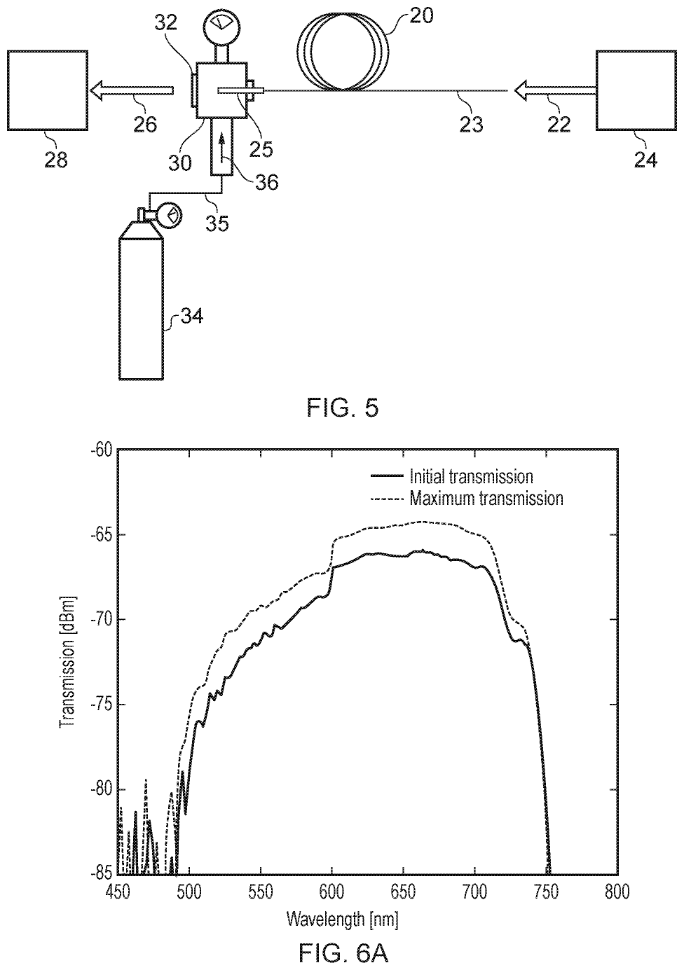

FIG. 5 shows a schematic representation of an experimental arrangement used to assess the effect of a differential refractive index on fibre attenuation. A length of hollow core fibre 20 about 20 m long was used. Light 22 emitted from an optical source 24 was coupled into an input end 23 of the fibre 20. The optical source 24 was either a white light source or a supercontinuum source according to the wavelength range of interest. The inputted light 22 was transmitted along the fibre 20 and emitted as an output 26 at the other end 25 of the fibre 20, where it was detected using an optical spectrum analyser (OSA) 28 in order to obtain spectral discrimination of the transmitted optical power.

The output end 25 of the fibre 20 was mounted inside a gas chamber 30 with an optical window 32 that allowed transmission of the emitted light 26 to the OSA 28. A lens system and a portion of multimode fibre (neither shown) were used to couple the emitted light 26 from the window 32 into the OSA 28. A gas canister 34 was coupled to the gas chamber 30 via a gas line 35 in order to deliver gas 36 to the interior of the gas chamber 30. Once inside the gas chamber 30, the gas 26 was able to flow into the core and cladding of the hollow core fibre 20 via open ends of the voids and spaces at the end facet of the output end 25 of the fibre 20. In this way, gas was able to be introduced into the hollow core fibre. Gases used included argon and compressed dry air (CDA).

In a first experiment, gas was introduced into the fibre over a period of time, the fibre having all the cladding and core holes open at the input and output ends of the fibre. In other words, gas was free to enter both the core and the cladding at the output end 25, and to leave from the input end 23. This provided passive venting of the gas into the surrounding atmosphere. It is also possible to use active venting by providing a venting arrangement operable to remove or withdraw gas from a hollow core fibre.

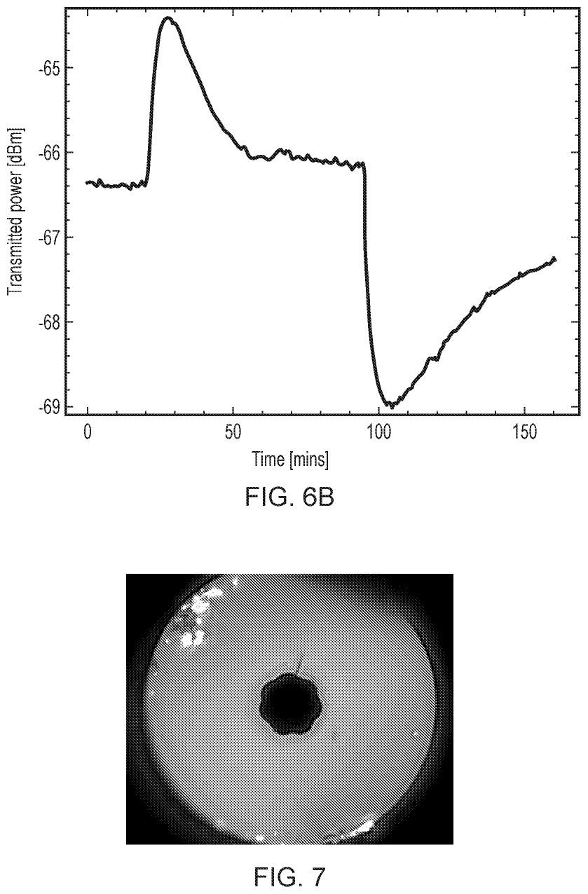

FIG. 6A shows a graph of transmitted optical power detected by the OSA over wavelength, in other words, power spectra of the transmitted light. The solid line indicates a power spectrum detected before the application of gas, with the core and the cladding at equal pressures. The dashed line indicates a power spectrum measured while gas was being introduced, showing how the transmission is improved. The spectrum covers the visible range, obtained from the white light source.

FIG. 6B shows a graph of transmitted optical power at 680 nm over time, as the fibre was filled with gas and then emptied. From an initial power level, the amount of transmitted power first increases (and hence the loss or attenuation decreases) as the fibre fills with gas. During the first part of filling, the core, being about twice as wide as capillary holes, fills about four times faster than the cladding. Hence, there is period of time during which the gas pressure in the core is higher than in the cladding, giving a higher refractive index in the core than in the cladding capillaries, which decreases fibre loss. Then, the capillaries also fill with gas, the pressure becomes more similar to that in the core, and the refractive index difference is reduced then eliminated. The loss therefore increases again, so the amount of detected power decreases and then stabilises at a lower level. Then, venting was carried out to remove gas from inside the fibre. This has the opposite effect from filling. The larger core empties first, giving a lower pressure and refractive index in the core than in the cladding. This reversed refractive index differential causes an increased attenuation, and the transmitted power is significantly reduced. The cladding then also empties, more slowly, and the difference in refractive index is gradually reduced so that attenuation is also reduced and the transmitted power level starts to rise.

These results demonstrate that a difference in refractive index between the core and the cladding of a hollow core fibre affects the optical properties of the fibre, and that a suitable differential in refractive index can be achieved by providing different gas contents for the core compared to the cladding. The effects are reversible by removal of the gas, and the size and direction of the differential affect the direction and amount of modification that can be produced. Hence, the use of gas filling to induce a difference in refractive index between core and cladding in a hollow core fibre is a highly versatile and effective way to modify and adjust the optical properties of the fibre, allowing detailed post-fabrication tailoring of the fibre's performance.

In order to confirm the results of the first experiment, a second experiment was carried out. Initially, the output end of the fibre was modified by heating the end of the fibre in order to collapse the capillary structure at the end facet. This closes or seals the cladding region. Once inside the gas chamber and exposed to gas, only the core region of the hollow core fibre is now able to fill with gas. No gas can be introduced into the cladding.

FIG. 7 shows a scanning electron microscope image of the end of the fibre sealed in this way.

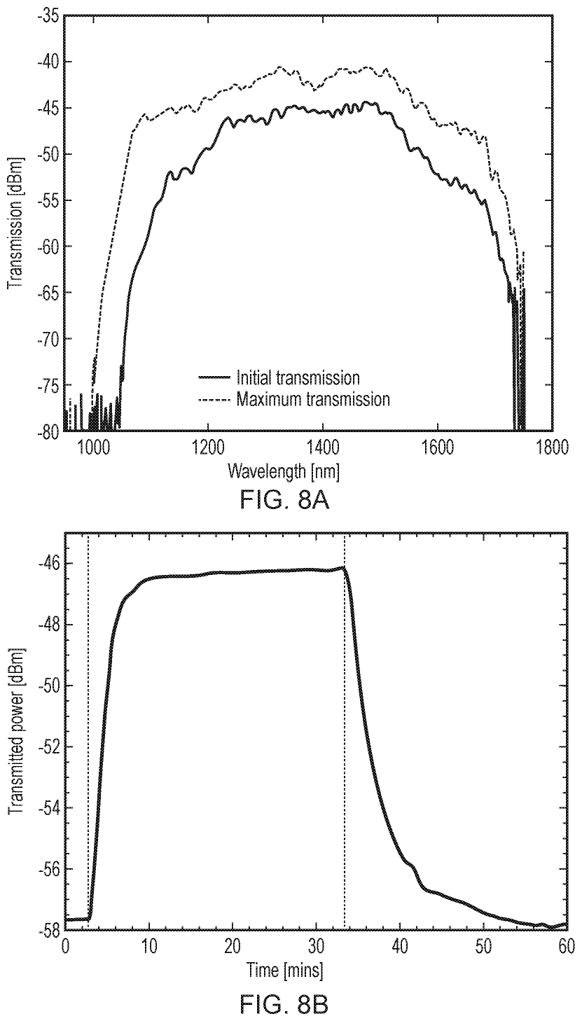

FIG. 8A shows a graph of transmitted optical power detected by the OSA over wavelength, in other words, power spectra of the transmitted light for the second experiment. In this case, a supercontinuum source was used to provide light over the near-infrared range. The solid line indicates a power spectrum detected before the application of gas, with the core and the cladding at equal pressures. The dashed line indicates a power spectrum measured while gas was being introduced, showing how the transmission is improved.

FIG. 8B shows a graph of transmitted optical power at 1100 nm over time, as the fibre was filled with gas and then emptied. Investigation at a different wavelength in this second experiment demonstrates the general applicability of the concept. As noted above, the gas entered the core only. As the core fills, which happens relatively rapidly owing to the size of the core diameter, the amount of transmitted power shows a rapid and dramatic increase, indicating a corresponding reduction in attenuation in the fibre. This is attributable to the difference in gas content between the core, which has been filled with gas at above atmospheric pressure, and gas content in the cladding, which has received no additional gas and remains filled with the original air at atmospheric pressure. Note the size of the improvement in transmission; in this near-infrared region the fibre is inherently quite lossy without any refractive index differential, so the gas filling provides a highly beneficial improvement. Once the core is fully filled with the introduced gas, the power level stabilises; no further improvement is seen. However, there is also no decline, since the cladding cannot receive gas. The effect is permanent rather than transitory, indicating that adding gas to a hollow core fibre to produce a difference in refractive index, and sealing the voids to retain the gas content of the core and the cladding is a technique for permanently modifying an optical fibre. The fibre was vented to remove the gas from the core, starting at about 34 minutes, causing a rapid decrease in transmitted power back to the original level, as the refractive index differential is lost.

These results show that the optical properties of a hollow core fibre can be modified or tuned very significantly by introducing a refractive index differential between the core and the cladding. As demonstrated, the differential can be achieved by configuring the gas contents of the core and the cladding to have different pressures, or by using different types or species of gas or mixtures of gases for each gas content, or a combination of these approaches. In any arrangement, however, the difference in refractive index will typically be very small (pressure-induced refractive index changes in a gas are not large) and it is therefore a surprising effect that such significant changes in optical properties can be achieved. For example, the refractive index of air (at standard temperature and pressure) is 1.00027. This can be considered as 1+0.00027*p where p is the air pressure in atmospheres (where one atmosphere is roughly equal to one bar, or 100 kPa). Hence, a refractive index change induced by, for example, a pressure of 4 bar in the core compared to 1 bar in the cladding is only about 0.001. However, it is important to also appreciate that this refractive index change is in fact very significant when compared to the even smaller differences between the effective refractive indices experienced by the core guided modes and the cladding modes in a hollow core fibre. As noted above, refractive index difference is not exploited as a guidance mechanism in hollow core fibres, so the effective indices are typically about equal. In this context, even a small change induced by gas filling can significantly change the coupling between these modes (and hence the fibre's optical properties), and can also effectively modify the fibre guidance mechanism to include total internal reflection (analogously with the guidance mechanism in a solid core fibre).

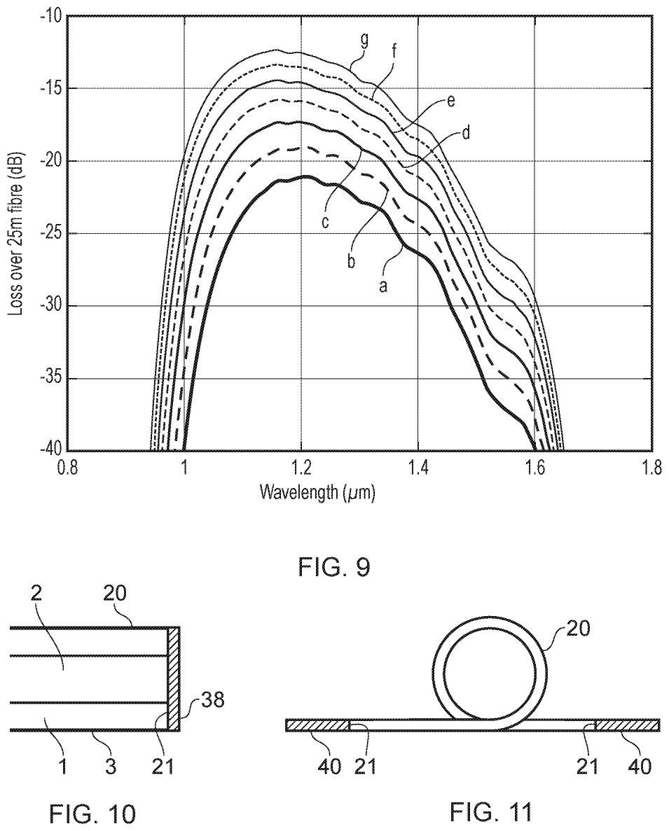

FIG. 9 shows a graph of results obtained from computer modelling carried out to demonstrate this point. The graph plots optical loss or attenuation over a 25 m length of fibre of the type shown in FIG. 4, for light with a similar near-infrared bandwidth to that used in the experiment of FIGS. 8A and 8B. As in the experiment, in the simulation the pressure in the core was increased, with the cladding maintained at atmospheric pressure. The lowest curve a shows the loss for the fibre without any induced refractive index differential, in other words, both the core and the cladding at atmospheric pressure (1 bar). Curves b-g show the loss for different values of gas pressure in the core, from 2 bar to 7 bar at 1 bar increments, corresponding to pressure differences between the core and the cladding of 1 bar to 6 bar (the cladding remaining at 1 bar). The decrease in loss with increasing pressure can be readily appreciated. Hence, the attenuation of a hollow core fibre can be substantially reduced by this technique, and can be closely tailored to a desired value for a particular wavelength or wavelengths of interest by creating a corresponding difference in refractive index.

This ability to set a particular attenuation (or other optical characteristic, as discussed further below) by selection or control of the different gas contents in the cladding capillaries and the hollow core can be utilised in permanent and temporary ways. To achieve a permanent modification to the optical properties, the ends of a portion of hollow core fibre can be closed or sealed after the appropriate gas content has been configured, in order to retain the gas inside the core and/or the cladding as appropriate. One technique for closing the cladding is to collapse the capillary structure at the end facets of the fibre, as mentioned above and shown in FIG. 7.

FIG. 10 shows a schematic representational side view of an end of a hollow core fibre 20, having, as before, a hollow core 2 surrounded by a structured cladding 1 and an outer cladding or jacket 3. The end facet 21 is covered with a layer of sealant material 38 which is applied over the end facet 21 after the gas content of the fibre 20 has been finalised, in order to seal both the core and the cladding so that the gas content (pressure and gas composition) of each is retained. The sealant material may comprise, for example, an adhesive or a cement material, or a layer of glass or polymer applied in a molten state and allowed to harden. Other suitable sealant materials will be apparent to the skilled person.

FIG. 11 shows a schematic side view (not to scale) of a further hollow core fibre 20 sealed to retain its gas content in a different manner. In this example, each end facet 21 of the hollow core fibre is spliced to a portion of all-solid optical fibre 40. This hermetically seals the gas inside the hollow core fibre, and seals the core separately from the cladding to maintain the difference in gas content. Also, the solid fibre portions can be used to couple the hollow core fibre 20 to optical apparatus, which is often designed and configured to connect with the more common solid fibre rather than hollow core fibre.

After sealing in any of these or other known ways, the modified hollow core optical fibre can be used as required, for example by being incorporated into a larger arrangement such as an optical device, apparatus or system.

The reversible nature of the effects caused by gas filling, enabled by removal or venting of the gas, offer the ability to configure a device, apparatus or system comprising or including the hollow core fibre to be tunable, with gas added or removed as required to achieve a particular level of an optical characteristic of interest. As an example, a length of hollow core fibre might be configured to be tuned in this way so as to be operable as a variable optical attenuator. A sealed connection between the fibre and a gas source can be provided to allow gas to added and removed as required, possibly under control of a suitably programmed controller for automated operation. Gas introduction and venting might be achieved via a gas chamber as in the example apparatus of FIG. 5, although other arrangements may be used as convenient.

Since all the voids inside a hollow core fibre (core and cladding capillaries) are accessible from one or both end facets of a length of the fibre, for either a permanent or temporary modification, gas may be conveniently introduced and removed via one or both ends of a fibre. Depending on the effect required, gas may be connected at one end, and the other end may be open or sealed. An open far end allows the newly added gas to push out existing air, while a closed far end will cause the pressure to rise more quickly. An open far end could be sealed during the gas introduction, for example once air has been forced out. See the example arrangement in FIG. 5, where gas is added through one end of the fibre. Two gas sources may be provided, one linked to the core and one linked to the cladding, to achieve different gas contents in each where neither the core or the cladding is to be kept at atmospheric pressure and air-filled.

An alternative arrangement is to form one or more holes, apertures or inlets in the side wall of a hollow core fibre, and inject gas into the fibre and/or remove gas from the fibre via this aperture. Conveniently, the aperture may communicate with the hollow core space, allowing the gas content of the core to be configured via the aperture. The end facets of the fibre can be sealed or closed so that gas added through the side aperture cannot escape through the fibre ends. Such an arrangement is suitable for permanent or temporary modification. For temporary modification, for example to implement a tunable device, the side access for the gas is useful because both ends of the fibre are free for the coupling of light into and out of the fibre.

As noted, the difference in refractive index can be achieved by various arrangements of gas content within the fibre. Firstly, consider the cladding as a single entity in which all capillaries have the same gas content. The core may be filled with gas at a first pressure, and the cladding capillaries may be filled with gas at a second pressure. The first pressure may be higher than the second pressure, or the second pressure may be higher than the first pressure, depending on the desired modification. Either of the first pressure or the second pressure may be atmospheric pressure. Either the core or the cladding may contain no gas, and may instead be in vacuum condition, having had the air therein evacuated.

For all and any of these various combinations, the core and the cladding may contain the same gas, so that the refractive index difference is achieved solely by providing a pressure difference. Alternatively, the core and the cladding may contain different gases, so that any inherent difference in the refractive index properties of the gas can supplement the pressure-induced refractive index difference. This includes the case where one of the core or the cladding contains air while the other has had a different gas introduced.

As another alternative, the gas in either or both of the core and the cladding may be a single gas type or species, or may be mixture of more than one type or species of gas. A mixture may be used to provide a further degree of freedom for tailoring the refractive index, for example. A mixture includes the instance where gas is introduced into a space that already includes air, and the air is not all pushed out of the space but remains to mix with the added gas.

As a still further alternative, the cladding capillaries can be treated separately, with one or more having a different gas content from the others (different pressure, atmospheric pressure, vacuum, different gas or gas mixture). While this is more complex to achieve than a uniform treatment of the cladding capillaries, it allows still finer tuning of the refractive index difference between the cladding and the core.

In a yet further alternative, the gas within the core or the cladding can be selected so as to have an optical resonance (for example an absorption feature) that matches an intended wavelength of operation of the hollow core fibre. As an example, the core may be filled with one gas type and the cladding filled with another gas type. At a specific wavelength, the gas in the core may have a resonance feature (such as an absorption feature), and therefore have a corresponding sharp (usually small) change in refractive index over a narrow wavelength range at the resonance feature. This will cause a further change in the differential refractive index between the core and cladding, just over the narrow wavelength range of the absorption feature. This provides a way for some selected wavelengths (those “on resonance”) to experience a fibre with different optical properties than those experienced by other, off-resonance, wavelengths.

Various optical properties of a hollow core fibre can be modified using the techniques disclosed herein. As shown in the experimental results of FIGS. 6A, 6B, 8A and 8B, one property is attenuation, or optical propagation (transmission) loss. This can be modified in either direction. A core refractive index which is higher than the cladding refractive index reduces attenuation, and a core refractive index which is lower than the cladding refractive index increases attenuation.

Other properties can be modified, tailored or otherwise controlled by setting a suitable refractive index difference. One example is differential loss between various modes able to propagate in the fibre. Loss for particular modes can be increased or decreased to change the overall modal content that the fibre can support, for example the number of core-guided modes. This can enable improvements such as higher power delivery, enhanced performance for optical sensing where mode stability is important, such as fibre gyroscopes, and the suppression of higher order modes which are undesirable for applications such as data transmission.

Another example is bend loss; this is an important consideration for many optical fibre applications, and can be significantly modified by control of differential refractive index. Further properties that can be engineered in this way include group velocity dispersion, birefringence and numerical aperture.

Considering modal content in more detail, hollow core fibres have a core radius which is very much larger than the wavelength of the light they carry, and the core is able to support a multitude of air-guided modes. The overall structure of the core and the cladding, in particular the ratio of the core size to the cladding capillary size, determines how many and which modes are able to be successfully propagated. Some modes are coupled out of the core and into lossy air modes in the cladding and are thereby suppressed. For example, a photonic bandgap fibre, having capillaries which are much smaller than the core size, will typically be intrinsically few-moded. The larger capillary sizes possible in an antiresonant fibre allow single mode operation to be achieved.

The refractive index modification available via the present concept allows some post-fabrication alteration or tuning of the modality of a fibre, giving some design flexibility for any given core and cladding size and structure. For example, a fibre which is designed to be a single mode fibre, i.e. it is configured to support a single propagating mode in the hollow core, can be made multimode or few-moded. In an anti-resonant fibre, few-moded operation can be produced by making the cladding capillaries smaller, and increasing their number, but the reduced capillary diameter increases the confinement loss. Overall the effect is that it is not possible to achieve a few-moded antiresonant fibre in which all the modes have the same low loss as the one mode in a single mode antiresonant fibre. However, by taking a single mode antiresonant fibre with relatively large cladding capillaries, and altering the gas content as described herein to increase the refractive index of the core compared to that in the cladding (such as by increasing the core pressure), it is possible to achieve a low loss few moded fibre. Applications for which this would be useful include the delivery of multimode or few mode laser beams (that is, beams with M²>1), and data transmission using multimode beams from vertical cavity surface-emitting lasers.

Conversely, a fibre which is designed to be multimode can be modified to become single mode, by configuring the gas content such that the cladding has a higher refractive index than the core, such as by decreasing pressure in the core and/or increasing pressure in the cladding. For example, photonic bandgap fibres which are inherently few-moded could be made truly single mode. This could improve the performance of these fibres in applications for which they are otherwise well-adapted, such as data transmission and gyroscopic fibre sensors. This approach could also be used in antiresonant fibres, for example those having a relatively large core size such that the corresponding capillary size is small so as to not support single mode operation without a refractive index modification.

The numerical aperture of a solid core optical fibre is determined by the refractive index difference between the core and the cladding, and increasing the numerical aperture can be useful for some applications, such as increasing mode confinement, reducing bend loss, and increasing collection efficiency for back-scattered light. The same effect, or indeed the opposite effect of reducing numerical aperture, can be achieved in hollow core fibre by using the present concept to introduce a refractive index differential between the core and the cladding. Increasing the core refractive index such as by increasing gas pressure in the core can increase the numerical aperture of the fibre.

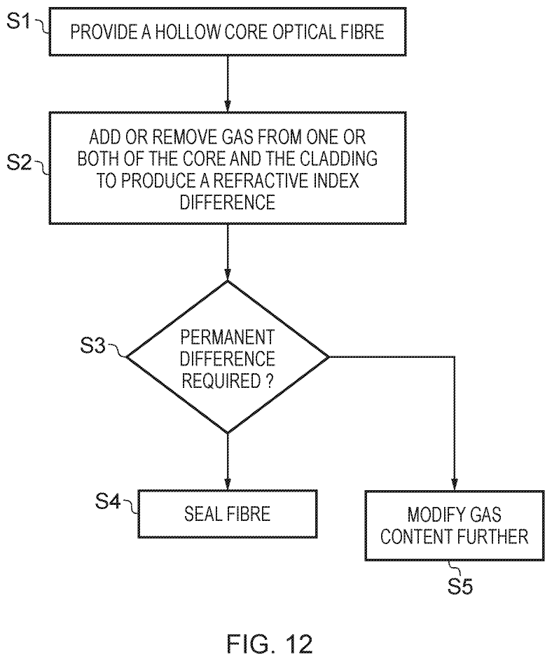

FIG. 12 shows a flow chart of steps in an example method according to the present disclosure. In a first step S1, a hollow core optical fibre is provided. The fibre can be any type of hollow core fibre with a structured cladding, including but not limited to any of the specific examples described herein. In a second step S2, gas is added or removed to either or both of the hollow core and the cladding capillaries in order to change the gas content and produce a corresponding refractive index difference between the core and the cladding. The introduction and/or removal of gas can be performed according to any of the examples herein or by other approaches that will be apparent to the skilled person as suitable for achieving a differential refractive index.

The next step S3 in the method asks whether the induced refractive index difference is intended to be permanent or not. If it is, the method proceeds to step S4, in which the fibre is sealed to retain the particular gas content and the refractive index difference achieved in step S2, according to but not limited to any of the example sealing methods proposed herein. If a permanent difference is not required, for example if the fibre is comprised in tunable optical arrangement, the method proceeds to step S5 instead of step S4, in which the gas content of the core and/or the cladding can be modified again at a future time to alter the refractive index difference as required.

The value or size of the refractive index produced between the core and the cladding can be selected according to the type and amount of optical property modification which is required. The difference may be positive or negative, in other words, the core index may be greater than the cladding index, or the core index may be smaller than the cladding index. As noted above, however, typically a relatively small difference is sufficient to achieve usable and useful modification of one or more optical properties. For example, argon gas could be used in the core and cladding; this has a refractive index at 1 atm of 1.000281. If the cladding is at atmospheric pressure, and the pressure in the core is raised, for each bar increase in pressure, the core index increases by about 0.000281. Experiments up to about 8 bar, giving an index difference of about 0.00225 (around 0.2% above the cladding index at 1 atm), have shown that this amount of differential still has a significant impact on the fibre characteristics. Accordingly, a refractive index difference between the core and the cladding of less than one percent can be useful, including less than 0.5%, less than 0.3%, less than 0.2% and less than 0.1%. Higher pressures are possible to obtain the larger of these differentials. An upper limit on usable pressures will exist, owing to various factors. These include mechanical failure of the thin walls of the cladding tubes, and possible permeation of gas through these walls. The maximum usable pressure will likely depend on the particular design of hollow core fibre, including parameters such as cladding wall thickness and curvature. There is also the state change of the gas into a liquid to consider, which will put a limit on maximum achievable pressure; this will vary according to the type of gas.

A variety of different gases may be used, having regard to their refractive index values. Some example suitable gases, together with their refractive index values at 1 atm and 1° C., fora wavelength of 589 nm, are:

| | |
|---|---|
| Air | 1.0002926 |
| Ammonia | 1.000374 |
| Argon | 1.000281 |
| Carbon dioxide | 1.000452 |
| Carbon monoxide | 1.000482 |
| Carbonyl sulphide | 1.001476 |
| Chlorine | 1.000772 |
| Deuterium | 1.0001265 |
| Dimethyl ether | 1.000891 |
| Ethylene | 1.000696 |
| Fluorine | 1.000195 |
| Helium (natural) | 1.000036 |
| Hydrogen | 1.000138 |
| Hydrogen bromide | 1.00014 |
| Hydrogen cyanide | 1.000447 |
| Hydrogen iodide | 1.000906 |
| Hydrogen sulphide | 1.00063 |
| Krypton | 1.000427 |
| Methane | 1.000444 |
| Neon | 1.000067 |
| Nitric oxide | 1.000297 |
| Nitrogen | 1.000297 |
| Nitrous oxide | 1.000516 |
| Oxygen | 1.000272 |
| Sulphur dioxide | 1.000686 |
| Sulphur hexafluoride | 1.000786 |
| Sulphur trioxide | 1.000737 |
| Water (vapour) | 1.000254 |
| Xenon | 1.000642 |

As noted above, gases can be used alone, or in combination as a mixture of two or more different gases in order to further tailor the refractive index.

Various factors can be considered when selecting a gas or gases to be used. A gas with a particularly low or high refractive index can produce a bigger differential refractive index between the core and the cladding. A gas which is considered inert is unlikely to react with surfaces within the fibre to cause permanent changes to the fibre's optical properties. A gas with low permeability through silica may be most suitable for silica fibres, in order to retain the gas inside the relevant holes in the fibre. For this reason, helium and hydrogen may be less attractive for use with silica fibres. Taking all these factors into account, carbon dioxide may be generally useful in a wide range of circumstances, but the invention is not limited in this regard, and the gas type can be chosen as desired.

As noted above, either or both of gas pressure and gas type/composition can be used to achieve the refractive index difference between the core and the cladding. However, the range of differential refractive indexes accessible by gas composition alone is smaller than that offered by gas pressure.

A simple approximation for the dependence of the refractive index on gas pressure can be found if the gas is considered to behave as an ideal gas. The refractive index, n, is a function of gas density, ρ, and is given by the expression:

$$( n - 1 ) ∝ \text{?}$$

$$\text{?} \text{indicates text missing or illegible when filed}$$

For an ideal gas with pressure P and temperature T,

$$ρ ∝ \frac{P}{T}$$

So, the refractive index of an ideal gas can be approximated as:

$$\text{?} = 1 + a \text{?}$$

$$\text{?} \text{indicates text missing or illegible when filed}$$

where a is specific to the gas type.

For example, consider argon, where a=0.000281, and n=1.000281 at atmospheric pressure and n=1.00281 at 10 bars. It is known that hollow core fibres can tolerate gas pressures beyond 100 bar for equal core and cladding pressure). The relationship between refractive index and pressure does begin to deviate from the above linear approximation at higher pressures, but the following values derived from the linear relationship illustrate, purely as an example, the refractive index range that can be achieved by pressurising for argon gas.

| Pressure (bar) | Refractive index |
|---|---|
| 1 | 1.000281 |
| 5 | 1.001405 |
| 10 | 1.00281 |
| 20 | 1.00562 |
| 40 | 1.01124 |
| 60 | 1.01686 |
| 100 | 1.0281 |

The pressure range over which the linear relationship is sufficient is dependent on the gas type, but it is nevertheless clear that using pressurisation a wide range of refractive index values can be achieved. To get a general idea of refractive index ranges which may be achieved with different gas species, the same method as explained above for argon here can be applied to the other gas species listed above.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] WO 2015/040187
[2] WO 2015/040189
[3] WO 2019/025797
[4] U.S. Pat. No. 9,904,008
[5] WO 2015/185761
[6] S E Barkou et al, “Photonic bandgap fibers”, LEOS '99, IEEE Lasers and Electro-Optics Society 1999 12th Annual Meeting, vol. 2 IEEE 1999
[7] J Broeng et al, “Analysis of air-guiding photonic bandgap fibers”, Optics Letters vol. 25(2), pp 96-98, 2000
[8] Francesco Poletti, “Nested antiresonant nodeless hollow core fiber,” Opt. Express, vol. 22, pp. 23807-23828, 2014
[9] J R Hayes et al, “Antiresonant hollow core fiber with an octave spanning bandwidth for short haul data communications”, Journal of Lightwave Technology vol. 35(3), 437-442 (2017)

1. A hollow core optical waveguide comprising:
a hollow core; and
a structured arrangement of longitudinally extending capillaries surrounding the hollow core to form a cladding; wherein
one or both of the hollow core and the cladding contains gas configured to provide a refractive index difference between the hollow core and the cladding.

2. A hollow core optical waveguide according to claim 1, wherein both the hollow core and the cladding contain gas.

3. A hollow core optical waveguide according to claim 2, wherein the hollow core and the cladding contain a same gas species or mixture, the gas in the hollow core being at a first pressure and the gas in the cladding being at a second pressure different from the first pressure.

4. A hollow core optical waveguide according to claim 2, wherein the hollow core contains a first gas species or mixture, and the cladding contains a second gas species or mixture different from the first gas species of mixture.

5. A hollow core optical waveguide according to claim 1, wherein one of the hollow core or the cladding contains no gas so as to be at vacuum pressure.

6. A hollow core optical waveguide according to claim 1, wherein different capillaries of the cladding differently contain gas to provide a refractive index difference between at least two of the capillaries.

7. A hollow core optical waveguide according to claim 1, wherein the hollow core has a refractive index higher than a refractive index of the cladding capillaries.

8. A hollow core optical waveguide according to claim 1, wherein the hollow core has a refractive index lower than a refractive index of the cladding capillaries.

9. A hollow core optical waveguide according to claim 1, wherein the hollow core optical waveguide is a photonic bandgap optical fibre configured to guide light along the hollow core by a photonic bandgap effect, the cladding comprising a microstructured regular array of longitudinally extending capillaries.

10. A hollow core optical waveguide according to claim 1, wherein the hollow core optical waveguide is an antiresonant optical fibre configured to guide light along the hollow core by an antiresonant effect, the cladding comprising a ring of longitudinally extending capillaries.

11. A hollow core optical waveguide according to claim 1, wherein the hollow core and/or the capillaries are sealed by a sealant material applied to end facets of the optical waveguide.

12. A hollow core optical waveguide according to claim 1, wherein the cladding is sealed by a collapse of the structured arrangement of the capillaries at the ends of the optical waveguide.

13. A hollow core optical waveguide according to claim 1, comprising a portion of solid core optical fibre spliced to each end facet of the optical waveguide to seal the core and the cladding.

14. A hollow core optical waveguide according to claim 1, comprising one or more apertures in a side wall of the optical waveguide through which gas can be introduced into or removed from the hollow core.

15. An optical device, optical apparatus or optical system comprising one or more hollow core optical waveguides according to claim 1.

16. A method of modifying optical properties of a hollow core optical waveguide, comprising:
providing a hollow core optical waveguide comprising a hollow core and a structured arrangement of longitudinally extending capillaries surrounding the hollow core to form a cladding; and
changing a gas content of one or both of the hollow core and the cladding in order to achieve a refractive index difference between the hollow core and the cladding.

17. A method according to claim 16, wherein changing the gas content comprises introducing gas into one or both of the hollow core and the cladding.

18. A method according to claim 16, wherein changing the gas content comprises removing gas from one or both of the hollow core and cladding.

19. A method according to claim 16, further comprising, after changing the gas content, sealing the hollow core and/or the cladding at each end of the hollow core optical fibre in order to fix the gas content and the refractive index difference.

20. A method according to claim 19, wherein sealing the hollow core and/or the cladding comprises one or more of: applying a sealant material to end facets of the optical waveguide, collapsing the structured arrangement of the capillaries at the ends of the optical waveguide, and splicing portions of solid core optical fibre to end facets of the optical waveguide.

21. A method according to claim 16, further comprising making an additional change or changes to the gas content at one or more later times in order to alter the refractive index difference.

22. A method according to claim 16, wherein changing the gas content comprises introducing or removing gas via one or both ends of the optical waveguide.

23. A method according to claim 16, wherein changing the gas content comprises introducing or removing gas via one or more apertures in a side wall of the optical waveguide.
